(19) United States
(12) Patent Application Publication
(10) Pub. No.: US 2022/0146962 A1
(43) Pub. Date: May 12, 2022

(54) CARRIER LIQUID FILTRATION UTILIZING ELECTRIC FIELDS

(71) Applicant: Hewlett-Packard Development Company, L.P., Spring, TX (US)

(72) Inventors: Igor Chertov, Ness Ziona (IL); Doron Schlumm, Ness Ziona (IL); Sergei Trifonov, Ness Ziona (IL)

(73) Assignee: Hewlett-Packard Development Company, L.P., Spring, TX (US)

(21) Appl. No.: 17/416,548

(22) PCT Filed: Jul. 31, 2019
(86) PCT No.: PCT/US2019/044282

§ 371 Date: Jun. 21, 2021

(51) Int. Cl. G03G 15/08; B03C 5/02

(52) U.S. Cl. CPC G03G 15/0887; B03C 5/02

(57) ABSTRACT

In an example of the disclosure, carrier liquid is supplied to a container with a set of walls defined at least partially by a surface of an electrode. The carrier liquid is caused to move through a container via a carrier liquid flow path to sequentially encounter a set of accumulation elements. Each accumulation element is situated between adjacent walls. A voltage is applied to the electrode to generate an electric field between the electrode surface and the set of accumulation elements. The electric field causes contaminant from the carrier liquid to adhere to the set of accumulation elements.

### BACKGROUND

A print apparatus may apply a print agent to a paper or another substrate. In one example, a print apparatus may apply a print agent that is an electrostatic printing fluid (e.g., electrostatically chargeable toner or resin colorant particles dispersed or suspended in a carrier liquid). Such a system is commonly referred to as a LEP printing system. In other examples, a print apparatus may apply a print agent via a dry toner or inkjet printing technologies.

### DRAWINGS

FIG. 1 is a block diagram depicting an example of a system for carrier liquid filtration utilizing electric fields.

FIG. 2 is a block diagram depicting another example of a system for carrier liquid filtration utilizing electric fields.

FIG. 3 is a block diagram depicting a memory resource and a processing resource to implement an example of a method for filtration of contaminants from carrier liquid utilizing electric fields.

FIGS. 4A-4C illustrate an example of a system for carrier liquid filtration utilizing electric fields.

FIG. 5 is a block diagram that illustrates an example of a printer apparatus that includes a system for carrier liquid filtration utilizing electric fields.

FIG. 6 is a schematic diagram illustrating an example of a liquid electrophotography printer apparatus that includes a system for carrier liquid filtration utilizing electric fields.

FIG. 7 is a flow diagram depicting an example implementation of a filtration method to remove contaminant from carrier liquid utilizing electric fields.

### DETAILED DESCRIPTION

In an example of LEP printing, a printer may form an image on a print substrate by placing an electrostatic charge on a photoconductor, and then utilizing a laser scanning unit, LED writing head, or other writing component to apply an electrostatic pattern of the desired image on the photoconductor to selectively discharge the photoconductor. The selective discharging forms a latent electrostatic image on the photoconductor. The printer includes a development station to develop the latent image into a visible image by applying a thin layer of electrostatic ink (which may be generally referred to as “LEP ink”, or “electronic ink” in some examples) to the patterned photoconductor. Charged toner particles in the LEP ink adhere to the electrostatic pattern on the photoconductor to form a liquid ink image. In examples, the liquid ink image, including colorant particles and a carrier liquid, is transferred utilizing a combination of heat and pressure from the photoconductor to an intermediate transfer member (“ITM”). In an example, the ITM may be, or may be attached to, a rotatable drum. In another example, the ITM may be a belt driven that is to be driven by a series of rollers. In examples the ITM may be a consumable or replaceable ITM. The ITM is heated until carrier liquid evaporates and colorant particles melt, and a resulting molten film representative of the image is applied to a substrate to form a printed image upon the substrate.

In examples, the photoconductor surface upon which the latent electrostatic image is to be formed has had a thin layer of carrier liquid, e.g., an imaging oil, applied. The carrier liquid layer is to facilitate the application of ink layers from the development station to the photoconductor surface. In certain applications, the carrier liquid layer may be a residual from a wiping operation performed by a cleaning station for the photoconductor. In certain applications, the cleaning station will apply a thin layer, e.g. a 10-100 nm, of carrier liquid to extend the lifespan and performance of the photoconductive surface (e.g., delay/slow down the rate of oxidization of carrier liquid). In certain applications, carrier liquid will additionally facilitate the transfer of inked images from the photoconductor surface to the ITM.

A significant challenge with some LEP printers, however, is that contaminants in the carrier liquid can cause significant print quality issues and damage to equipment. In some situations, the contaminant to the carrier liquid may be used ink particles left over from a prior printing cycle. In some situations, the contaminant to the carrier liquid may be dust and/or fiber particles, e.g. dust created, or particles dislodged, as the printable substrate is transported during printing operations. Print quality can be affected as the LEP writing component's selective discharging of the photoconductor to form a latent image is impaired by the contaminants.

In some applications, mechanical filtration systems to filter carrier liquid have been used. However mechanical filtration systems may not be effective to improve print quality in all cases. In certain scenarios mechanical filtering of carrier liquid to the extent needed for acceptable print quality may require a significant amount of carrier liquid to be discarded. The expense associated with this loss of carrier liquid, and the expense of replacing mechanical filters, can be perceived negatively by LEP printer users.

To address these issues, various examples described in more detail below provide a system and a method for carrier liquid filtration utilizing electric fields. In an example, a filtration system includes an electrode having a surface, and a container that includes a set of walls defined at least in part by the surface of the electrode. Each of the walls of the set of walls includes a conduit. The filtration system includes a carrier liquid flow path and a set of accumulation elements. The carrier liquid flow path is defined at least in part by the walls and the conduits. Each accumulation element has an accumulation surface. A portion of each accumulation element is situated between adjacent walls. The electrode is to cause an electric field to be formed between the surface and the accumulation surface of each accumulation element. The carrier liquid is to encounter the electric field as the carrier liquid is moved along the flow path. Encountering the electric field causes non-liquid contaminant to adhere to the accumulation surfaces of the accumulation elements.

In an example, the carrier liquid flow path of the filtration system is to cause the carrier liquid to sequentially encounter each of the accumulation elements, such that non-liquid contaminant is to adhere to an accumulation surface of each accumulation element.

In an example, the set of accumulation elements is a set of electrically grounded discs mounted parallel to each other and through their centers to a rotatable shaft, such that the set of parallel discs can rotate about the shaft through the volume of carrier liquid to be filtered.

In an example, the filtration system includes a displacement element to displace non-liquid contaminant from the set of discs. In an example, the displacement element may include edges to cause scraping of surfaces of discs as the discs are rotated.

In a particular example, the displacement element may include a set of appendages, with each appendage having edges to engage opposing surfaces of a pair of adjacent discs and cause non-liquid contaminants to fall from the discs to a collection bin.

In an example of the disclosure, a filtration method includes supplying carrier liquid to a container with a set of walls defined at least partially by a surface of an electrode. The disclosed method includes causing the carrier liquid to move through a container via a carrier liquid flow path to sequentially encounter a set of accumulation elements. Each accumulation element is situated between adjacent walls. The disclosed method includes applying a voltage to the electrode to generate an electric field between the electrode surface and the set of accumulation elements, thereby causing contaminant from the carrier liquid to adhere to the set of accumulation elements. In an example, the set of accumulation elements is a set of electrically grounded discs mounted parallel to each other and through their centers to a common rotatable shaft, and the disclosed filtration method includes rotating the set of parallel discs about the common shaft through the volume of carrier liquid to be filtered. In an example, the disclosed filtration method includes moving the set of discs relative to a displacement member positioned in engagement with the set of discs to displace adhered contaminant from the discs.

In this manner, the disclosed system and method provide for effective and efficient filtration of contaminants from carrier liquid. The disclosure, when integrated within or utilized in association with a LEP printer, can reduce or limit print quality issues and the expense of wasted carrier liquid and replacing mechanical filters that can be associated with existing systems and method is certain circumstances. Users and providers of LEP printing devices will also appreciate the reductions in damage to photoconductors, ITMs, and other printer components and the reductions in downtime afforded by the effective removal of contaminants from carrier liquid. Installations and utilization of printers that include the disclosed method and system for carrier liquid filtration utilizing electric fields should thereby be enhanced.

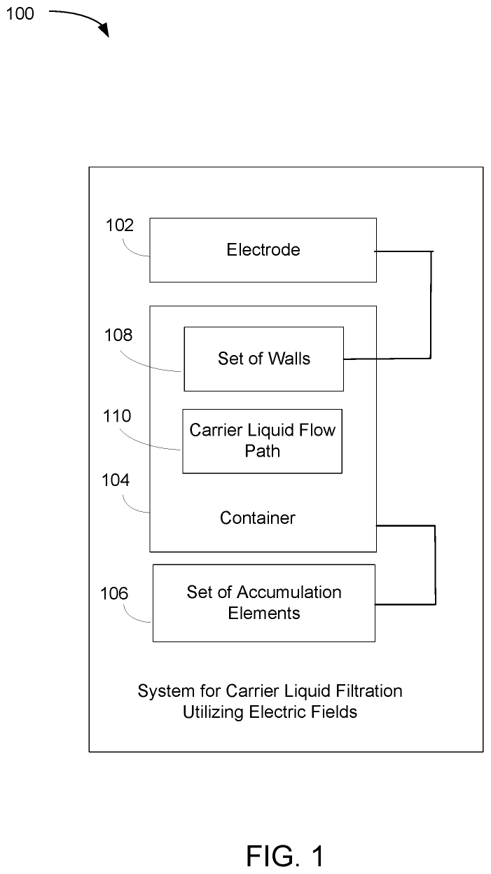

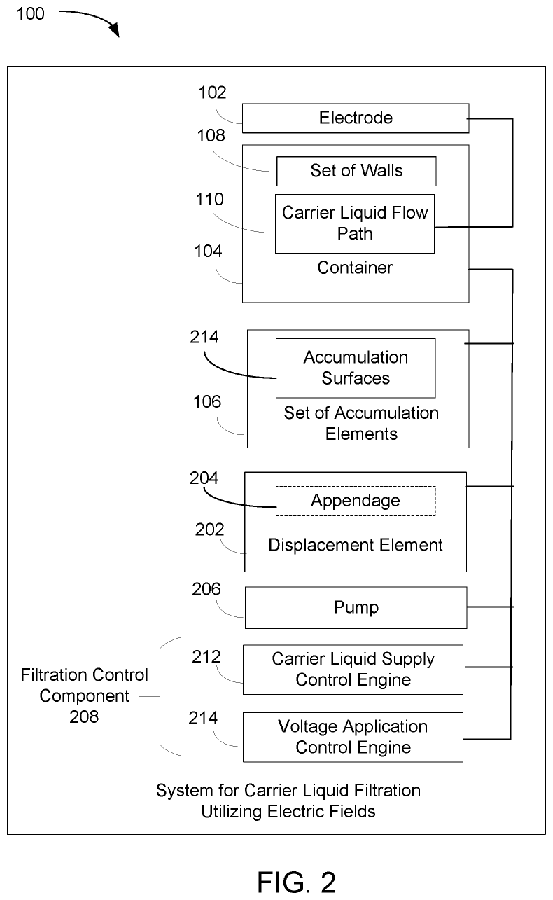

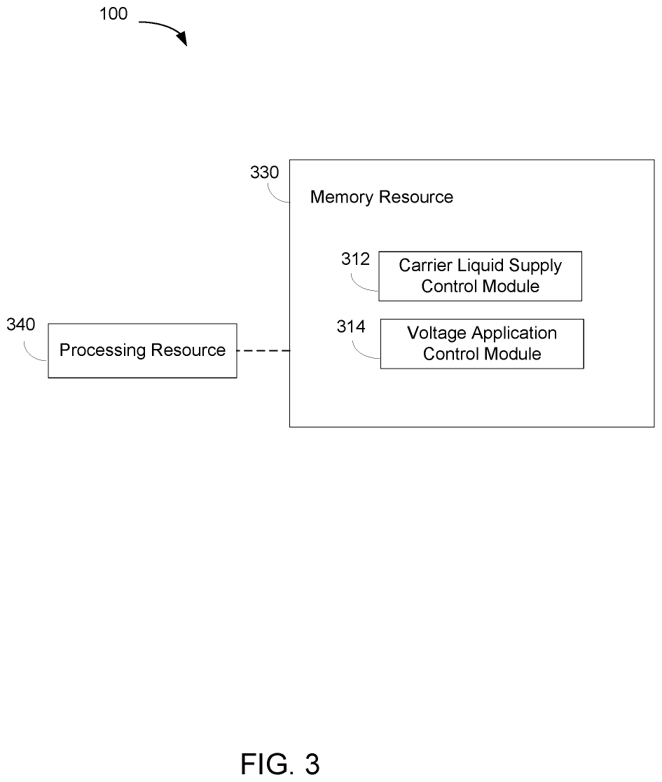

FIGS. 1 and 2 depict examples of physical and logical components for implementing various examples. In FIG. 2 various components are identified as engines 212 and 214. In describing engines 212 and 214 focus is on each engine's designated function. However, the term engine, as used herein, refers generally to hardware and/or programming to perform a designated function. As is illustrated with respect to FIG. 3, the hardware of each engine, for example, may include one or both of a processor and a memory, while the programming may be code stored on that memory and executable by the processor to perform the designated function. FIG. 1 is a block diagram depicting an example of a system 100 for servicing a drum at a printer. In this example, system 100 includes an electrode 102, a container 104, and a set of accumulation elements 106. As used herein, an “electrode” refers generally to a conductor through which electricity enters or leaves an object, substance, or region. Electrode 102 has a surface. In examples electrode 102 may be, or have a surface coating of, a conductive metal such as copper or aluminum. In examples electrode 102 may be electrically connected to a power supply (e.g. a high-voltage power supply) (not shown in FIG. 1). In some examples, the electrode 102 may be a negative electrode. In some examples, each accumulation element of the set of accumulation elements 106 is electrically grounded. Thus, in examples an electric field may be generated from electrode 102 towards the accumulation elements 106, without an electric current or voltage being applied directly to accumulation elements 106. In other examples, in order to establish the electric field a specific voltage may also be applied to the accumulation elements 106, such that electrode 102 and accumulation elements 106 are charged at different levels.

Container 104 is a container into which carrier liquid may be input. As used herein, “carrier liquid” refers generally to a viscous liquid that is combined with non-liquid colorant particles for use in printing operations, e.g. LEP printing operations. In examples the carrier liquid may be a petroleum-based liquid, e.g. an imaging oil. Container 104 includes a set of walls 108 that are defined at least in part by a surface of electrode 102. Each of the walls includes a conduit. Container 104 includes a carrier liquid flow path 110 that is defined at least in part by the walls 108 and the conduits in the walls 108. In an example, the conduits of adjacent walls 108 are situated closer to the tops of the walls than to the bottoms of the walls, so as to promote accumulation of carrier liquid between the adjacent walls.

In an example, a portion of each accumulation element 106 is situated between adjacent walls of the set of walls 108. Each accumulation element 106 includes an accumulation surface. Electrode 102 is to cause an electric field to be formed between the surface of electrode 102 and the accumulation surface of each accumulation element 106. The carrier liquid is to encounter the electric field as the carrier liquid is moved along the flow path. The carrier liquid encountering the electric field causes non-liquid contaminant (e.g. dried ink, dust, substrate fibers) to adhere to the accumulation surfaces of the accumulation elements.

In examples, each accumulation element of the set of accumulation elements 106 is mounted through its center to a rotatable shaft, such that the set of accumulation elements are able to rotate about the shaft, through the volume of carrier liquid. In an example, each of the accumulation elements of the set is mounted in parallel relative to the other, with substantially equal spacing between each pair of adjacent accumulation elements.

In examples, each accumulation element of the set of accumulation elements 106 may be relatively thin, such that the surface area of the edge of each accumulation element can be considered negligible. In some examples, the accumulation elements may taper towards the edge so as to reduce the surface area of the edges of the accumulation elements. By reducing the surface area of the edges of the accumulation elements, the sides (i.e. the faces) of each accumulation element serve as the accumulation surfaces rather than the edge (i.e. around the perimeter of the accumulation element). In some examples, each accumulation element 106 may comprise, or be shaped as, a disc. For example, the accumulation elements may be substantially circular in shape.

FIG. 2 is a block diagram depicting another example of a system for carrier liquid filtration utilizing electric fields. In the example of FIG. 2, in addition to the components described with respect to FIG. 1, system 100 also includes a displacement element 202, a pump 204, and a filtration control component 208.

Displacement element 202 is to displace non-liquid contaminant from the set of accumulation elements 106. In an example, displacement element 202 is to displace the non-liquid contaminant from the accumulation surfaces 216 of the accumulation elements 106. Displacement element 202, in some examples, includes an edge (e.g., a scraper edge or blade edge) to scrape or wipe non-liquid contaminant that has accumulated on the accumulation surfaces 216 off the accumulation surfaces. In an example, system 100 includes a collection bin, positioned adjacent to container 104. The bin is for collection of the non-liquid contaminants that fall from the accumulation surfaces 216 of the accumulation elements 106 as the accumulation surfaces encounter edges of displacement elements 202.

Continuing at FIG. 2, displacement element 202 may, in some examples, include a set of appendages 204 to engage an accumulation surface of accumulation elements 106. In some examples, each appendage of the set of appendages 204 is to engage opposing surfaces of a pair of adjacent accumulation elements 106. In examples, the appendages 204 of displacement element 202 may be sized to fit between adjacent accumulation elements 106, such that, as accumulation elements 106 rotate about an axis, the appendages 204 scrape or wipe the accumulation surfaces 216 of accumulation elements 106 to displace the non-liquid contaminant that has adhered to the accumulation surfaces 216. The displaced non-liquid contaminants are thereby prevented from re-entering the carrier liquid in the container 104 and potentially causing print quality issues and damage to equipment.

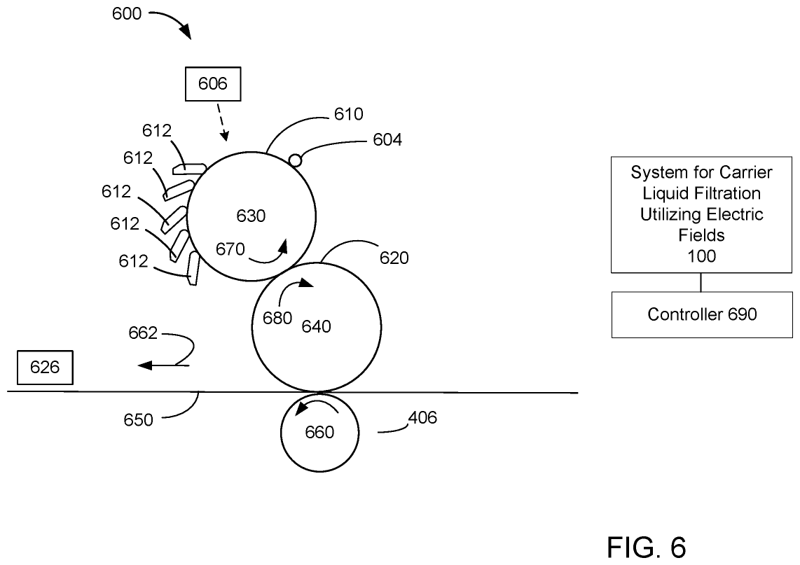

In the example of FIG. 2, system 100 includes a pump 206. Pump 206 represents generally an apparatus for mechanically moving a volume of carrier liquid from a printer component to the container, the carrier liquid to be filtered utilizing an electric field. In an example, pump 206 pushes the carrier liquid into the container 104 via an inlet conduit included in a first side of container 104. In an example the print component may be a print application cylinder having a photoconductive surface (e.g., 630 610, FIG. 6).

Continuing with the example of FIG. 2, system 100 includes a filtration control component 208 including a carrier liquid supply control engine 212 and a voltage application control engine 214. Carrier liquid supply control engine 212 represents generally represents generally a combination of hardware and programming to cause pump 206 to supply carrier liquid to container 104, container 104 including set of walls 108 defined at least partially by a surface of electrode 102. Carrier liquid supply control engine 212 causes the carrier liquid to move through container 104 via carrier liquid flow path 110. The carrier liquid moving through flow path 110 successively impacts, flows against, or otherwise encounters a set of accumulation elements 106, wherein each accumulation element of the set of accumulations elements 106 is situated between adjacent walls of the set of walls 108.

In a particular example, each of the set of accumulation elements 106 is mounted perpendicular to a common horizontal shaft, and carrier liquid supply control engine 212 causes a rotation of the accumulation elements about the common shaft. This rotation causes the vertically oriented accumulation elements 106 to rotate relative to the container. In a particular example, during rotation of an accumulation element at a time x wherein a first point on the circumference of the accumulation element is at a first rotational position and is immersed in a volume of carrier liquid that is pooled or flowing through container 104, a second point on the accumulation element circumference located 180 degrees opposite the first point is situated above and outside of the volume of carrier liquid. Continuing with this example, at a time y during the rotation wherein the accumulation element has rotated point 180 degrees from the first position, the first point on the circumference of the accumulation element is now above and outside the volume of carrier liquid while the second point on the circumference is immersed in the volume of carrier liquid.

Voltage application control engine 214 represents generally a combination of hardware and programming to apply a voltage to electrode 102 to generate an electric field between the surface of electrode 102 and set of accumulation elements 106. The generation of the electric field causing non-liquid contaminant from the carrier liquid to adhere to the set of accumulation elements 106. In general, the higher the voltage applied to electrode 102, the greater the development (e.g. attraction) of non-liquid contaminant on the accumulation surfaces 216 of the set of accumulation elements 106. However, for various reasons (e.g. energy reduction or safety), it may be intended that the voltage is restricted to a particular level. Thus, in some examples, a voltage of up to around 6 kiloVolts (kV) may be applied to electrode 102. In some examples, a voltage of between around 3.5 kiloVolts (kV) and around 4.5 kV may be applied to electrode 102. In other examples, a voltage of between around 4 kV and around 4.2 kV may be applied to electrode 102. In one example, a voltage of around 4.1 kV may be applied to electrode 102.

As noted above, in some printing systems, electrically-charged or electrostatically-charged print agent may be used and, in such systems, electrically-charged non-liquid print agent contaminant may be present in a carrier liquid. Therefore, the used carrier liquid may contain electrically-charged non-liquid print agent contaminant that has not been transferred onto the printable substrate. The generated electric field will act on the electrically-charged contaminant, causing it to be attracted to an accumulation surface 216 of an accumulation element, or of multiple accumulation elements, of the set of accumulation elements 106. A particle or piece of non-liquid contaminant may be caused to adhere to the accumulation surface to which it is closest. While the electric field exists between the surface of electrode 102 and the set of accumulation elements 106, the electrically-charged contaminant will be caused to accumulate on and adhere to the accumulation surfaces 216 of the accumulation elements.

In addition to electrically-charged contaminant and particles, non-electrically-charged contaminant, such as particles from the printable substrate (e.g. paper dust) may become electrostatically-charged as a result of the generated electric field. As such, any material that becomes electrostatically-charged is also attracted to the accumulation surfaces 216 of the accumulation elements 106. Since the liquid part (e.g. imaging oil) in the carrier liquid 106 is not electrically-charged, and does not become electrostatically-charged, it is not affected by the generated electric field. As a result, the non-liquid contaminant in the carrier liquid accumulates on the accumulation surfaces 216 of the accumulation elements 106 while the carrier liquid remains in the container 104.

In an example, while voltage application control engine 214 applies a voltage to electrode 102 to generate an electric field and causes non-liquid contaminant from the carrier liquid to adhere to the set of accumulation elements 106, the set of accumulation elements 106 are caused to move relative to a displacement element 202 positioned in engagement with the set of accumulation elements 106. This movement of the set of accumulation elements 106 is to cause an edge of the displacement element 202 to encounter adhered contaminant and remove, e.g. by scraping or wiping, the adhered contaminants from the accumulation elements 106. In one example, carrier liquid supply control engine 212 may cause the set of accumulation elements 106 to move by rotating the accumulation elements 106 around a common shaft or axis.

In the foregoing discussion of FIGS. 1 and 2, carrier liquid supply control engine 212 and voltage application control engine 214 were described as combinations of hardware and programming. Engines 212 and 214 may be implemented in a number of fashions. Looking at FIG. 3 the programming may be processor executable instructions stored on a tangible memory resource 330 and the hardware may include a processing resource 340 for executing those instructions. Thus, memory resource 330 can be said to store program instructions that when executed by processing resource 340 implement system 100 of FIG. 2.

Memory resource 330 represents generally any number of memory components capable of storing instructions that can be executed by processing resource 340. Memory resource 330 is non-transitory in the sense that it does not encompass a transitory signal but instead is made up of a memory component or memory components to store the instructions. Memory resource 330 may be implemented in a single device or distributed across devices. Likewise, processing resource 340 represents any number of processors capable of executing instructions stored by memory resource 330. Processing resource 340 may be integrated in a single device or distributed across devices. Further, memory resource 330 may be fully or partially integrated in the same device as processing resource 340, or it may be separate but accessible to that device and processing resource 340.

In one example, the program instructions can be part of an installation package that when installed can be executed by processing resource 340 to implement system 100. In this case, memory resource 330 may be a portable medium such as a CD, DVD, or flash drive or a memory maintained by a server from which the installation package can be downloaded and installed. In another example, the program instructions may be part of an application or applications already installed. Here, memory resource 330 can include integrated memory such as a hard drive, solid state drive, or the like.

In FIG. 3, the executable program instructions stored in memory resource 330 are depicted as carrier liquid supply control module 312 and voltage application control module 314. Carrier liquid supply control module 312 represents program instructions that when executed by processing resource 340 may perform any of the functionalities described above in relation to carrier liquid supply control engine 212 of FIG. 1. Voltage application control module 314 represents program instructions that when executed by processing resource 340 may perform any of the functionalities described above in relation to voltage application control engine 214 of FIG. 1.

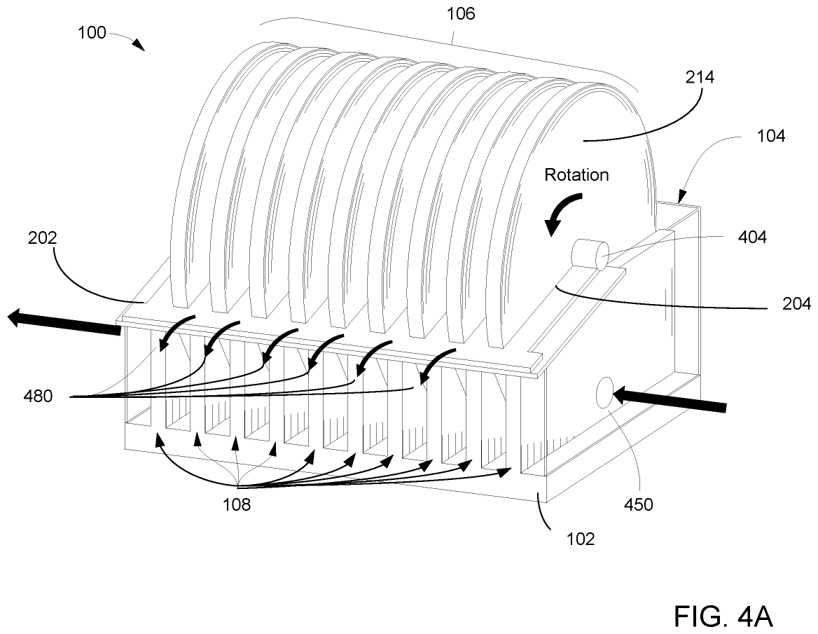

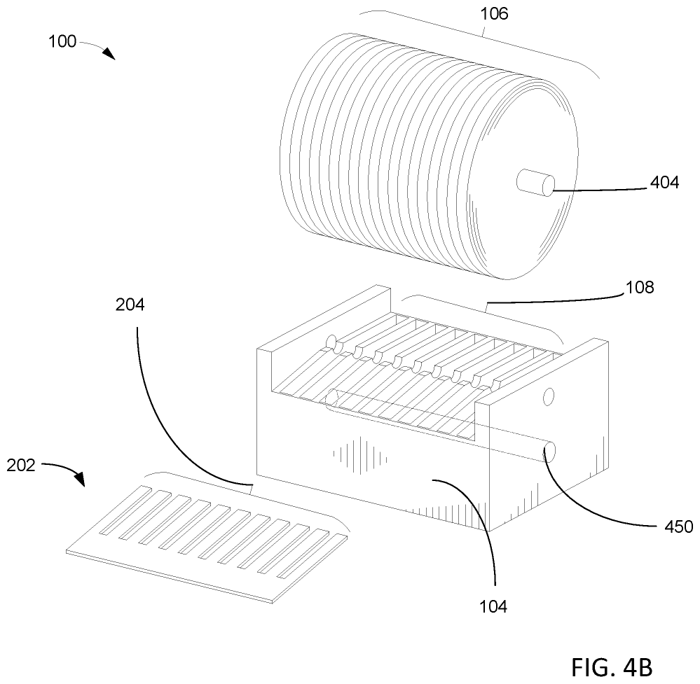

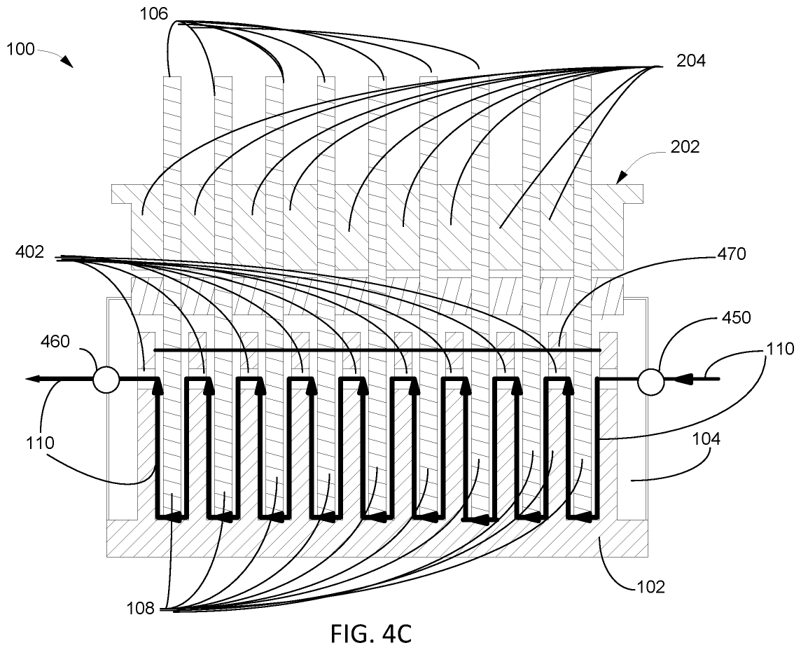

FIGS. 4A-4C illustrate an example of a system for carrier liquid filtration utilizing electric fields. In this example, system 100 includes an electrode 102, a container 104, and a set of accumulation discs 106. Electrode 102 has a surface that is formed in a shape such that the surface of electrode 102 at least partially define a set of walls 108 situated within container 104. In this manner, in the set of walls 108 are, or include, electrode 102. In examples electrode 102 may be, or have a coating of, a conductive metal such as copper or aluminum. In examples electrode 102 may be a negative electrode electrically connected to a power supply. In examples, each accumulation disc of the set of accumulation elements 106 is electrically grounded such that an electric field may be generated from electrode 102 towards the accumulation discs 106, without an electric current or voltage being applied directly to accumulation discs 106.

Moving to FIG. 4C, container 104 is a container into which carrier liquid may be input. In an examples the carrier liquid may be a petroleum-based imaging oil. Container 104 includes a set of walls 108 that are defined at least in part by a surface of electrode 102. Each of the walls 108 includes a conduit 402. In an example, container 104 may be sealed or closed so as to be watertight at its bottom and sides to prevent carrier liquid ingress into container except for through an inlet 450, and to prevent carrier liquid egress out of container 104 except through an outlet 460. In examples, container 104 may have a sealed interface or other watertight connection between the container and each of the walls 108 to prevent carrier liquid from bypassing any wall, conduits, or filtering stage.

Container 104 includes a carrier liquid flow path 110 that is defined at least in part by the walls 108 and the conduits 402 in the walls 108. In an example, the conduits 410 of adjacent walls of wall set 108 are situated closer to the tops of the walls than to the bottoms of the walls, to promote accumulation of carrier liquid between the adjacent walls. An example carrier liquid accumulation level 470 is illustrated in FIG. 4C. Other carrier liquid accumulation levels are possible and contemplated by this disclosure. In an example, a portion of each accumulation disc 106 is situated between adjacent walls of the set of walls 108 such that the portion is immersed in the accumulated carrier liquid.

Moving to FIG. 4B; each accumulation disc 106 includes an accumulation surface 216. Electrode 102 is to cause an electric field to be formed between the walls 108 defined at least in part by surface of electrode 102 and the accumulation surface 216 of each accumulation disc 106. In this example, the accumulation surfaces 216 are or include the flat portions (front and back) of each of accumulation discs 106.

Returning to FIG. 4C, the carrier liquid is to encounter the electric field as the carrier liquid is moved along flow path 110 (FIG. 4C). The carrier liquid encountering the electric field of container 104 and the walls 108 causes non-liquid contaminant (e.g. dried ink, dust, substrate fibers, etc.) to adhere to the accumulation surfaces 216 of the accumulation discs 106.

In the example of FIGS. 4A-4C, each accumulation disc of the set of accumulation discs 106 is mounted through its center to a rotatable shaft 404, such that the set of accumulation discs 106 are able to rotate about shaft 404, through the volume of carrier liquid. In an example, each of the accumulation discs of the set 106 is mounted in parallel relative to the other, with substantially equal spacing between each pair of adjacent accumulation discs.

In examples, each circular accumulation disc of the set of accumulation discs 106 may be thin, similar to a coin shape, such that the surface area of the edge of each accumulation disc can be considered negligible. In some examples, the accumulation discs 106 may taper towards the edge, similar to an athletic discus shape, so as to reduce the surface area of the edges of the accumulation discs.

Container 104 may include an inlet 450 to receive the carrier liquid containing non-liquid contaminant into the container 104, and an outlet 460 to allow filtered carrier liquid to flow out of container 104. In examples inlet 450 and/or outlet 460 may be or include a tube or fitting.

Continuing with the example of FIGS. 4A-4C, displacement element 202 is to displace non-liquid contaminant from the set of accumulation discs 106. In an example, displacement element 202 is to displace the non-liquid contaminant from the accumulation surfaces 216 of the accumulation discs 106. Displacement element 202, in some examples, includes an edge (e.g., a scraper edge or blade edge) to scrape or wipe non-liquid contaminant that has accumulated on the accumulation surfaces 216 off the accumulation surfaces.

Displacement element 202 may, in some examples, include a set of appendages 204 to engage an accumulation surface of accumulation discs 106. In some examples, each appendage of the set of appendages 204 is to engage opposing surfaces of a pair of adjacent accumulation discs 106. In examples, the appendages 204 of displacement element 202 may be sized to fit between adjacent accumulation discs 106, such that, as accumulation discs 106 rotate about an axis, the appendages 204 scrape or wipe the accumulation surfaces 216 of accumulation discs 106 to displace the non-liquid contaminant that has adhered to the accumulation surfaces 216. In an example the scraped or wiped non-liquid contaminant is to fall away 480 from container 104 and into a collection bin (not depicted in FIGS. 4A-4C). The displaced non-liquid contaminants are thereby prevented from re-entering the carrier liquid in the container 104 and potentially causing print quality issues and damage to equipment.

In the example of FIGS. 4A-4C, each of the set of accumulation discs 106 is mounted perpendicular to a common horizontal shaft 404, and carrier liquid supply control engine 212 causes a rotation of the accumulation discs about the common shaft. This rotation causes the vertically oriented accumulation discs 106 to rotate relative to the container such that during a complete rotation of a disc all of the accumulation surface (e.g. in this example the flat portions) of the disc is exposed to the carrier liquid held in container 104.

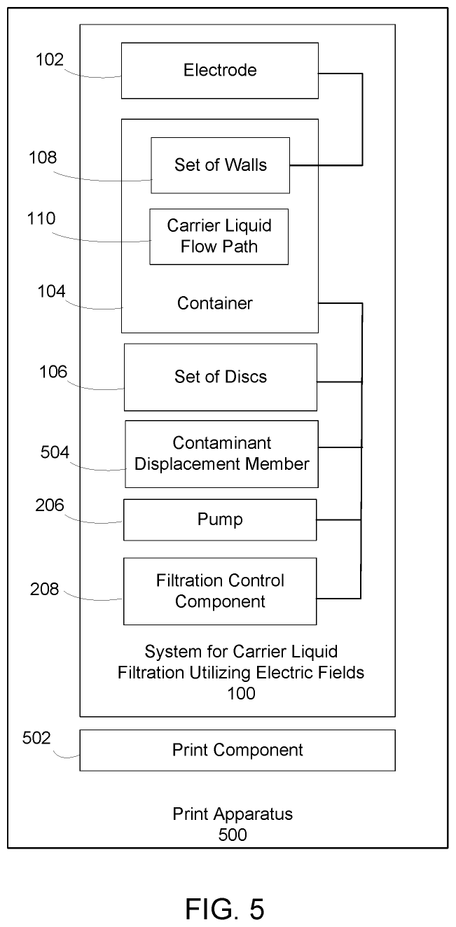

FIG. 5 is a block diagram that illustrates an example of a printer apparatus 500 that includes a system 100 for carrier liquid filtration utilizing electric fields and a print component 502. As used herein, a “printer apparatus” is synonymous with a “printing device” or “printer”, and refers generally to any electronic device or group of electronic devices that consumes the print agent to produce a printed print job or printed content. In examples, a printer may be, but is not limited to, an offset press, a liquid a liquid toner-based printer, an LEP printer, an inkjet printer, a jet-on-blanket inkjet printer, or a multifunctional device that performs a function such as scanning and/or copying in addition to printing. As used herein, a “print job” refers generally to content, e.g., an image, and/or instructions as to formatting and presentation of the content sent to a computer system for printing. In examples, a print job may be stored in a programming language and/or a numerical form so that the job can be stored and used in computing devices, servers, printers and other machines capable of performing calculations and manipulating data. As used herein, an “image” refers generally to a rendering of an object, scene, person, or abstraction such text or a geometric shape. As used herein, “print agent” refers generally to any substance that can be applied upon a substrate by a printer during a production printing operation, including but not limited to inks, primers and overcoat materials (such as a varnish), As used herein an “ink” refers generally to a fluid that is to be applied to a substrate during a printing operation to form an image upon the substrate.

Print component 502 represents generally a combination of hardware and programming to receive a digital image to be printed, and to cause print apparatus 500 to apply a print agent upon a substrate to form a printed image on the substrate. In an example wherein print apparatus 500 is a LEP printer, print component 502 may be or include a developer unit, a print application cylinder with a photoconductive surface, or an ITM cylinder with an ITM attached thereto, and the printing operation utilizes print agent that includes a non-liquid colorant and a liquid imaging oil carrier liquid. In an example wherein print apparatus 500 is an inkjet printer, print component 502 may be or include a thermal inkjet or a piezo inkjet printhead. In an example wherein print apparatus 500 is a jet-on-blanket inkjet printer, print component 502 may be or include a thermal or piezo inkjet printhead, a, and/or an ITM. In examples, the substrate may be in a sheet or page form. In examples the substrate may be or include, but is not limited to, paper, photo paper, canvas, fabric, synthetics, cardstock, cardboard, and/or corrugated material. In an example, system 100 includes a filtration control component 208. Filtration control component 208 represents generally a combination of hardware and software to cause a filtration operation at print apparatus 500. Filtration control component 208 is to cause a pump 206 at or adjacent to print apparatus 500 to move a volume of carrier liquid from the print component 502 to a container 104. Container 104 is to receive the volume of carrier liquid. Container 104 has a set of walls 108 that include, or otherwise are defined at least in part by, electrode 102, and has a carrier liquid flow path 110 that is at least partially defined by the walls 108 and a conduit of each of the walls.

Continuing with the example of FIG. 5, system 100 includes a set of accumulation elements with the shape of discs 106. Each accumulation element disc 106 has a contaminant receiving surface, e.g. an outer surface of the disc. Each accumulation element disc 106 is situated between adjacent walls of the set of walls 108, and is to be partially disposed within container 104 such that each disc is to be partially submerged in the volume of carrier liquid.

Filtration control component 208 is to cause application of a voltage to electrode 102. The voltage application causes an electric field to be formed between electrode 102 and the set of accumulation element discs 106, thereby causing non-liquid contaminant in the carrier liquid to adhere to the contaminant receiving surfaces. System 100 includes a contaminant displacement member 504 to displace non-liquid contaminant from the set of accumulation element discs. In an example, filtration control component 208 is to cause rotation of the set of accumulation element disc 106 around a common axis. In this example, contaminant displacement member 504 may include an edge to cause a scraping or wiping of the contaminant receiving surfaces of accumulation element discs 106 as the accumulation element discs 1068 are rotated about the axis.

FIG. 6 is a schematic diagram illustrating an example of a liquid electrophotography (“LEP”) printer apparatus that includes a system for filtration of carrier liquid utilizing electric fields at a LEP printer. In an example, an LEP printer 600 may include a print application cylinder 630 with a photoconductive surface 610, a charging device 604, a writing component 606, an ITM 620 positioned on an ITM cylinder 640, an impression cylinder 102, and a set of developer assemblies 612.

According to the example of FIG. 6, a pattern of electrostatic charge is formed on a photoconductive surface 610 by rotating a clean, bare segment of photoconductive surface 610 under charging device 604. Photoconductive surface 610 in this example is cylindrical in shape, e.g, is attached to print application cylinder 630, and rotates in a direction of arrow 670. In other examples, photoconductive surface 610 may be planar or part of a belt-driven system.

Charging device 604 may be or include a charge roller, corona wire, scorotron, or any other charging apparatus. A uniform static charge is deposited on photoconductive surface 610 by charging device 604. As photoconductive surface 610 continues to rotate, it passes a writing component 606 where one or more laser beams, LED, or other light sources dissipate localized charge in selected portions of photoconductive surface 610 to leave an invisible electrostatic charge pattern (“latent image”) that corresponds to the image to be printed. In some examples, charging device 604 applies a negative charge to the surface of photoconductive surface 610. In other implementations, the charge is a positive charge. Writing component 606 then selectively discharges portions of the photoconductive surface 610, resulting in local neutralized regions on the photoconductive surface 610.

Continuing with the example of FIG. 6, a set of developer assemblies 612 are disposed adjacent to photoconductive surface 610 and may correspond to various print fluid colors such as cyan, magenta, yellow, black, and the like. There may be one developer assembly 612 for each print fluid color. In other examples, e.g., black and white printing, a single developer assembly 612 may be included in LEP printer 600. During printing, the appropriate developer assembly 612 is engaged with photoconductive surface 610. The engaged developer assembly 612 presents a uniform film of print fluid to photoconductive surface 610. The print fluid contains electrically-charged non-liquid pigment particles which are attracted to the opposing charges on the image areas of photoconductive surface 610. The print fluid also contains a petroleum based imaging or other carrier fluid. As a result, photoconductive surface 610 has a developed image on its surface, i.e. a pattern of print fluid corresponding with the electrostatic charge pattern (also sometimes referred to as a “separation”).

The print fluid is transferred from the photoconductive surface 610 to ITM 620. ITM 620 may be in the form of an ITM attached to a rotatable ITM cylinder 640. In other examples, the ITM may be in the form of a belt or other transfer system. In this particular example, photoconductive surface 610 and ITM 620 are on cylinders 630 640 that rotate relative to one another, such that the color separations are transferred during the relative rotation. In the example of FIG. 6, ITM 620 rotates in the direction of arrow 680. The transfer of a developed image from photoconductive surface 610 to ITM 620 may be known as the “first transfer”, which takes place at a point of engagement between photoconductive surface 610 and ITM 620.

Once the layer of print fluid has been transferred to ITM 620, it is next transferred to a print substrate 650. In this example, print substrate is a web substrate 650 moving along a substrate path in a substrate path direction 662. In other examples, the print substrate may be a sheet substrate that travels along a substrate path. This transfer from ITM 620 to the print substrate 650 may be deemed the “second transfer”, which takes place at a point of engage between ITM 620 and print substrate 650. The impression cylinder 660 can both mechanically compress the print substrate into contact with ITM 620 and also help feed print substrate 650. In examples, print substrate 650 may be a conductive or a non-conductive print substrate, including, but not limited to, paper, cardboard, sheets of metal, metal-coated paper, or metal-coated cardboard. In examples, print substrate 650 with a printed image may be moved to a position to be scanned by an inline color measurement device 626, such as a spectrometer or densimeter, to generate optical density and/or background level data.

Controller 690 refers generally to any combination of hardware and software that is to control part, or all, of the LEP printer 600 components and print process. In examples, the controller 690 can additionally control a system 100 (FIGS. 1, 2, 3, 4A-4C) for filtration of carrier liquid utilizing electric fields. Non-exclusive examples of a system 100 for filtration of carrier liquid utilizing electric fields described in the foregoing paragraphs, including the descriptions of FIGS. 1, 2, 3, and 4A-4C.

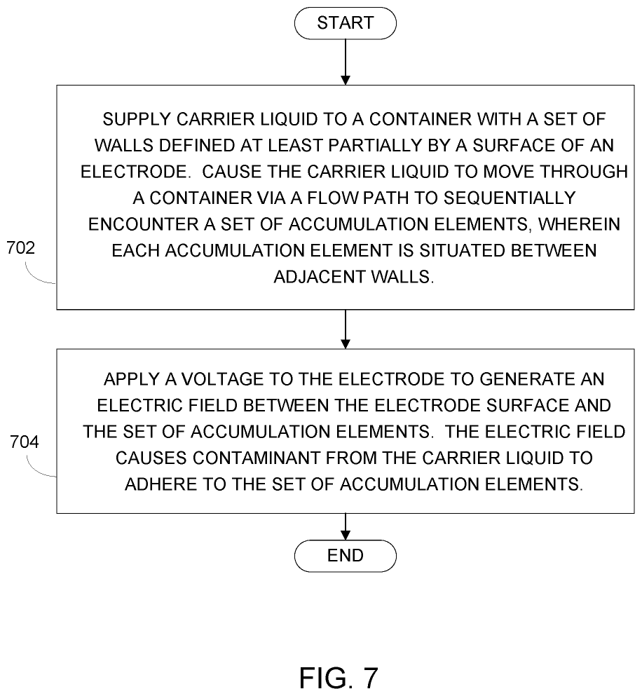

FIG. 7 is a flow diagram of implementation of a method for removing contaminant from carrier liquid. Carrier liquid is supplied to a container having a set of walls defined at least partially by a surface of an electrode. The carrier liquid is caused to move through a container via a carrier liquid flow path to sequentially encounter a set of accumulation elements. Each accumulation element is situated between adjacent walls (block 702), Referring back to FIGS. 2 and 3, carrier liquid supply control engine 212 (FIG. 2) or carrier liquid supply control module 312 (FIG. 3), when executed by processing resource 340, may be responsible for implementing block 702.

A voltage is applied to the electrode to generate an electric field between the electrode surface and the set of accumulation elements. The electric field causes contaminant from the carrier liquid to adhere to the set of accumulation elements (block 704). Referring back to FIGS. 2 and 3, voltage application control engine 214 (FIG. 2) or voltage application control module 314 (FIG. 3), when executed by processing resource 340, may be responsible for implementing block 704.

FIGS. 1-7 aid in depicting the architecture, functionality, and operation of various examples. In particular, FIGS. 1-6 depict various physical and logical components. Various components are defined at least in part as programs or programming. Each such component, portion thereof, or various combinations thereof may represent in whole or in part a module, segment, or portion of code that comprises executable instructions to implement any specified logical function(s). Each component or various combinations thereof may represent a circuit or a number of interconnected circuits to implement the specified logical function(s). Examples can be realized in a memory resource for use by or in connection with a processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is a non-transitory storage media that can contain, store, or maintain programs and data for use by or in connection with the instruction execution system. The term “non-transitory” is used only to clarify that the term media, as used herein, does not encompass a signal. Thus, the memory resource can comprise a physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory (EPROM), flash drives, and portable compact discs.

Although the flow diagram of FIG. 7 shows specific orders of execution, the order of execution may differ from that which is depicted. For example, the order of execution of two or more blocks or arrows may be scrambled relative to the order shown. Also, two or more blocks shown in succession may be executed concurrently or with partial concurrence. Such variations are within the scope of the present disclosure.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein. All of the features disclosed in this specification (including any accompanying claims, abstract and drawings), and/or all of the blocks or stages of any method or process so disclosed, may be combined in any combination, except combinations where at least some of such features, blocks and/or stages are mutually exclusive. The terms “first”, “second”, “third” and so on in the claims merely distinguish different elements and, unless otherwise stated, are not to be specifically associated with a particular order or particular numbering of elements in the disclosure.

What is claimed is:

1. A filtration system, comprising:
an electrode having a surface;
a container, the container including
a set of walls defined at least in part by the surface of the electrode,
wherein each of the walls includes a conduit;
a carrier liquid flow path defined at least in part by the walls and the conduits;
a set of accumulation elements, each accumulation element having an accumulation surface;
wherein a portion of each accumulation element is situated between adjacent walls;
wherein the electrode is to cause an electric field to be formed between the surface and the accumulation surface of each accumulation element; and
wherein the carrier liquid is to encounter the electric field as it is moved along the flow path, thereby causing non-liquid contaminant to adhere to an accumulation surface of an accumulation element.

2. The filtration system of claim 1, wherein the set of accumulation elements is a set of discs.

3. The filtration system of claim 1, wherein the carrier liquid flow path is to cause carrier liquid to sequentially encounter each of the accumulation elements, such that non-liquid contaminant is to adhere to an accumulation surface of each accumulation element.

4. The filtration system of claim 1, wherein container is watertight at t bottom and sides, and includes
an inlet conduit to receive the carrier liquid containing non-liquid contaminant into the container; and
an outlet conduit to allow filtered carrier liquid to flow out of the container.

5. The filtration system of claim 1, wherein the conduits of adjacent walls are situated closer to the top of the walls than to the bottom of the walls, so as to promote accumulation of carrier liquid between the adjacent walls.

6. The filtration system of claim 1, wherein the set of accumulation elements are electrically grounded.

7. The filtration system of claim 1, wherein each of the set of accumulation elements is mounted through its center to a rotatable shaft, such that the set of accumulation elements are able to rotate about the shaft and through the volume of carrier liquid.

8. The filtration system of claim 7, wherein the set of accumulation elements are mounted parallel to one another, with substantially equal spacing between each adjacent pair of accumulation elements.

9. The filtration system of claim 1, further comprising a displacement element to displace non-liquid contaminant from the set of accumulation elements.

10. The filtration system of claim 9, wherein the displacement element incudes an edge to cause a scraping or wiping of a surface of an accumulation element as the accumulation element is rotated.

11. The filtration system of claim 9, wherein the displacement element includes set of appendages, each appendage having edges to engage opposing surfaces of a pair of adjacent accumulation elements and cause the non-liquid contaminant to fall to a collection bin.

12. A filtration method to remove contaminants from carrier liquid, the method comprising:
supplying carrier liquid to a container with a set of walls defined at least partially by a surface of an electrode;
causing the carrier liquid to move through a container via a carrier liquid flow path to sequentially encounter a set of accumulation elements, wherein each accumulation element is situated between adjacent walls; and
applying a voltage to the electrode to generate an electric field between the electrode surface and the set of accumulation elements, thereby causing contaminant from the carrier liquid to adhere to the set of accumulation elements.

13. The filtration method of claim 12, further comprising:
rotating the set of accumulation elements about a common shaft, such that the accumulation elements rotate relative to the container.

14. The filtration method of claim 12; further comprising:
moving the set of accumulation elements relative to a displacement member positioned in engagement with the set of accumulation elements to displace adhered contaminant from the accumulation elements.

15. A print apparatus comprising:
a print component to print onto a printable substrate during a printing operation utilizing an imaging oil;
a system for removing non-liquid contaminants from the imaging oil, including
a pump to move a volume of the imaging oil from the print component to a container;
the container to receive the volume of imaging oil, the container having a set of walls defined at least in part by a surface of an electrode, and having a carrier liquid flow path at least partially defined by the walls and a conduit of each of the walls;
a set of discs, each disc having a contaminant receiving surface, wherein each disc is situated between adjacent walls and partially disposed within the container, such that each disc is partially submerged in the volume of imaging oil;
wherein, when a voltage is applied to the electrode, an electric field is formed between the electrode and the set of discs, thereby causing non-liquid contaminant in the imaging oil to adhere to the contaminant receiving surfaces; and
a contaminant displacement member to displace non-liquid contaminant from the set of discs.
